(19) United States
(12) Patent Application Publication
(10) Pub. No.: US 2016/0140507 A1
(43) Pub. Date: May 19, 2016

(54) OPTIMIZING SERVICE PROVIDER SCHEDULE AND ROUTE

(71) Applicant: INTRENATIONAL BUSINESS MACHINES CORPORATION, Armonk, NY (US)

(72) Inventors: Mark B. Stevens, Austin, TX (US); John D. Wilson, Houston, TX (US)

(21) Appl. No.: 14/546,141

(22) Filed: Nov. 18, 2014

(51) Int. Cl. G06Q 10/10

(52) U.S. Cl. CPC G06Q 10/1095; G06Q 10/1097

(57) ABSTRACT

A method, system or computer usable program product for optimizing a service provider schedule and route including receiving a service request from a customer, the service request including customer timing and location requirements; retrieving, from a service information system, service timing and inventory for performing a service to fulfill the service request; retrieving, from a scheduling system, a set of gaps in schedules that meet the customer timing and location requirements for a set of service providers which meet the service timing and inventory requirements, each schedule gap having a respective prior and subsequent location; utilizing a processor to determine an optimal schedule appointment for a first one of the set of service providers to perform the service during a first one of the set of schedule gaps, the optimal determination including service timing; transmitting an offer to the customer for the first service provider to perform the service to fulfill the service request during the optimal schedule appointment in the first schedule gap; and responsive to receiving a confirmation from the customer, scheduling the optimal schedule appointment during the first schedule gap of the first service provider.

### BACKGROUND

1. Technical Field

The present invention relates generally to managing a service provider schedule and route, and in particular, to a computer implemented method for optimizing a service provider schedule and route based upon customer geographic locations and nearby opportunities.

2. Description of Related Art

A mobile workforce can include a variety of traditional service providers such as plumbers, HVAC repairmen, and cable installers as well as less traditional providers such as at commercial IT support specialists and home yoga instructors. Managing schedules for these service providers was and often still is performed manually. That is, a manager may allocate and give a service provider a list of services to perform in a given day with addresses that are generally close together. The order of the services to be performed may be included with the list of services, or it may be left up to the service provider to make that determination. This results in customers being told to expect the service provider on a given day or perhaps half day with little assurance that the service provider will actually arrive during the period provided.

More recently, a variety of scheduling systems have been developed to assist in this scheduling. These systems may take into travel time to determine a preferred route for each service provider and expected time for a service provider to complete a scheduled task.

### SUMMARY

The method, system or computer usable program product for optimizing a service provider schedule and route including receiving a service request from a customer, the service request including customer timing and location requirements; retrieving, from a service information system, service timing and inventory for performing a service to fulfill the service request; retrieving, from a scheduling system, a set of gaps in schedules that meet the customer timing and location requirements for a set of service providers which meet the service timing and inventory requirements, each schedule gap having a respective prior and subsequent location; utilizing a processor to determine an optimal schedule appointment for a first one of the set of service providers to perform the service during a first one of the set of schedule gaps, the optimal determination including service timing; transmitting an offer to the customer for the first service provider to perform the service to fulfill the service request during the optimal schedule appointment in the first schedule gap; and responsive to receiving a confirmation from the customer, scheduling the optimal schedule appointment during the first schedule gap of the first service provider.

### BRIEF DESCRIPTION OF THE SEVERAL VIEWS OF THE DRAWINGS

The novel features believed characteristic of the invention are set forth in the appended claims. The invention itself, further objectives and advantages thereof, as well as a preferred mode of use, will best be understood by reference to the following detailed description of illustrative embodiments when read in conjunction with the accompanying drawings, wherein:

FIG. 1 is a block diagram of an illustrative data processing system in which various embodiments of the present disclosure may be implemented;

FIG. 2 is a block diagram of an illustrative network of data processing systems in which various embodiments of the present disclosure may be implemented;

FIG. 3 is a block diagram of a service provider scheduling management system in which various embodiments may be implemented;

FIG. 4 is a flow diagram of a customer requesting a service appointment in which various embodiments may be implemented;

FIGS. 5 and 6 are a flow diagrams of value determinations for a possible schedule appointment in accordance with a first and a second embodiment;

FIG. 7 is a flow diagram for proposing changes in scheduling of appointments in which various embodiments may be implemented; and

FIG. 8 is a flow diagram for providing offers for services to potential customers in which various embodiments may be implemented.

### DETAILED DESCRIPTION

Processes and devices may be implemented and utilized for managing a service provider schedule. These processes and apparatuses may be implemented and utilized as will be explained with reference to the various embodiments below.

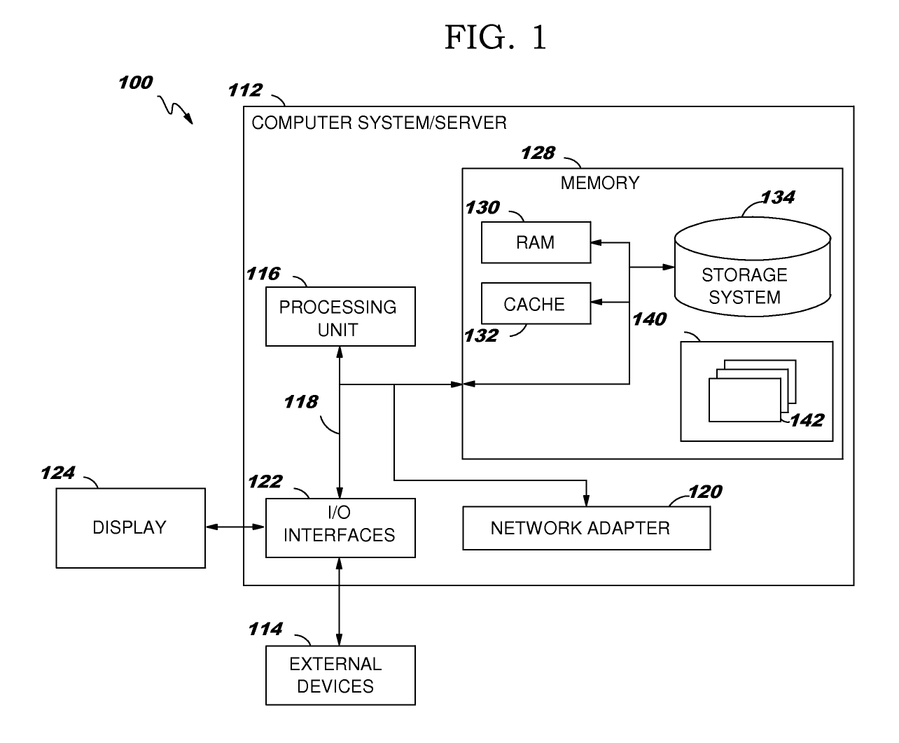

FIG. 1 is a block diagram of an illustrative data processing system in which various embodiments of the present disclosure may be implemented. Data processing system 100 is one example of a suitable data processing system and is not intended to suggest any limitation as to the scope of use or functionality of the embodiments described herein. Regardless, data processing system 100 is capable of being implemented and/or performing any of the functionality set forth herein such as managing a service provider schedule.

In data processing system 100 there is a computer system/server 112, which is operational with numerous other general purpose or special purpose computing system environments, peripherals, or configurations. Examples of well-known computing systems, environments, and/or configurations that may be suitable for use with computer system/server 112 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 112 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 112 may be practiced in distributed computing environments where tasks are performed by remote processing devices that are linked through a communications network. In a distributed computing environment, program modules may be located in both local and remote computer system storage media including memory storage devices.

As shown in FIG. 1, computer system/server 112 in data processing system 100 is shown in the form of a general-purpose computing device. The components of computer system/server 112 may include, but are not limited to, one or more processors or processing units 116, a system memory 128, and a bus 118 that couples various system components including system memory 128 to processor 116.

Bus 118 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 112 typically includes a variety of non-transitory computer system usable media. Such media may be any available media that is accessible by computer system/server 112, and it includes both volatile and non-volatile media, removable and non-removable media.

System memory 128 can include non-transitory computer system readable media in the form of volatile memory, such as random access memory (RAM) 130 and/or cache memory 132. Computer system/server 112 may further include other non-transitory removable/non-removable, volatile/non-volatile computer system storage media. By way of example, storage system 134 can be provided for reading from and writing to a non-removable, non-volatile magnetic media (not shown and typically called a “hard drive”). Although not shown, a USB interface for reading from and writing to a removable, non-volatile magnetic chip (e.g., a “flash drive”), and an optical disk drive for reading from or writing to a removable, non-volatile optical disk such as a CD-ROM, DVD-ROM or other optical media can be provided. In such instances, each can be connected to bus 118 by one or more data media interfaces. Memory 128 may include at least one program product having a set (e.g., at least one) of program modules that are configured to carry out the functions of the embodiments. Memory 128 may also include data that will be processed by a program product.

Program/utility 140, having a set (at least one) of program modules 142, may be stored in memory 128 by way of example, and not limitation, as well as an operating system, one or more application programs, other program modules, and program data. Each of the operating system, one or more application programs, other program modules, and program data or some combination thereof, may include an implementation of a networking environment. Program modules 142 generally carry out the functions and/or methodologies of the embodiments. For example, a program module may be software for managing a service provider schedule.

Computer system/server 112 may also communicate with one or more external devices 114 such as a keyboard, a pointing device, a display 124, etc.; one or more devices that enable a user to interact with computer system/server 112; and/or any devices (e.g., network card, modem, etc.) that enable computer system/server 112 to communicate with one or more other computing devices. Such communication can occur via I/O interfaces 122 through wired connections or wireless connections. Still yet, computer system/server 112 can communicate with one or more networks such as a local area network (LAN), a general wide area network (WAN), and/or a public network (e.g., the Internet) via network adapter 120. As depicted, network adapter 120 communicates with the other components of computer system/server 112 via bus 118. It should be understood that although not shown, other hardware and/or software components could be used in conjunction with computer system/server 112. Examples, include, but are not limited to: microcode, device drivers, tape drives, RAID systems, redundant processing units, data archival storage systems, external disk drive arrays, etc.

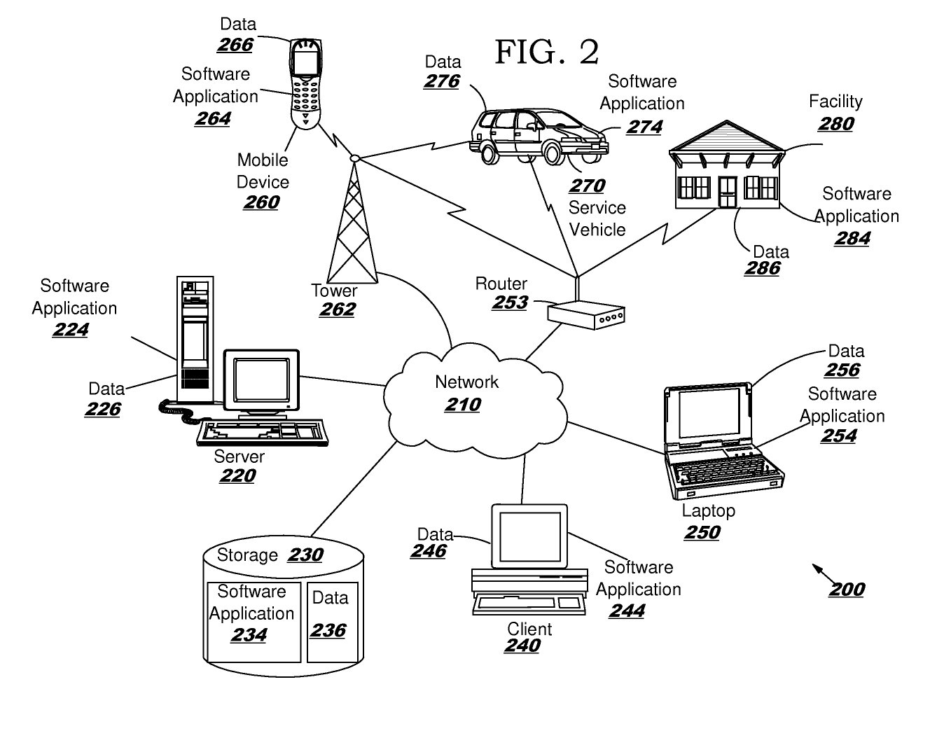

FIG. 2 is a block diagram of an illustrative network of data processing systems in which various embodiments of the present disclosure may be implemented. Data processing environment 200 is a network of data processing systems such as described above with reference to FIG. 1. Software applications such as for managing a service provider schedule may execute on any computer or other type of data processing system in data processing environment 200. Data processing environment 200 includes network 210. Network 210 is the medium used to provide simplex, half duplex and/or full duplex communications links between various devices and computers connected together within data processing environment 200. Network 210 may include connections such as wire, wireless communication links, or fiber optic cables.

Server 220 and client 240 are coupled to network 210 along with storage unit 230. In addition, laptop 250, service vehicle 270 and facility 280 (such as a home or business) are coupled to network 210 including wirelessly such as through a network router 253. A mobile phone 260 and service vehicle 270 may be coupled to network 210 through a mobile phone tower 262. Data processing systems, such as server 220, client 240, laptop 250, mobile phone 260, service vehicle 270 and facility 280 contain data and have software applications including software tools executing thereon. Other types of data processing systems such as personal digital assistants (PDAs), smartphones, tablets and netbooks may be coupled to network 210.

Server 220 may include software application 224 and data 226 for managing a service provider schedule or other software applications and data in accordance with embodiments described herein. Storage 230 may contain software application 234 and a content source such as data 236 for managing a service provider schedule. Other software and content may be stored on storage 230 for sharing among various computer or other data processing devices. Client 240 may include software application 244 and data 246. Laptop 250 and mobile phone 260 may also include software applications 254 and 264 and data 256 and 266. Service vehicle 270 and facility 280 may include software applications 274 and 284 and data 276 and 286. Other types of data processing systems coupled to network 210 may also include software applications. Software applications could include a web browser, email, or other software application for managing a service provider schedule.

Server 220, storage unit 230, client 240, laptop 250, mobile phone 260, service vehicle 270 and facility 280 and other data processing devices may couple to network 210 using wired connections, wireless communication protocols, or other suitable data connectivity. Client 240 may be, for example, a personal computer or a network computer.

In the depicted example, server 220 may provide data, such as boot files, operating system images, and applications to client 240 and laptop 250. Server 220 may be a single computer system or a set of multiple computer systems working together to provide services in a client server environment. Client 240 and laptop 250 may be clients to server 220 in this example. Client 240, laptop 250, mobile phone 260 and facility 280 or some combination thereof, may include their own data, boot files, operating system images, and applications. Data processing environment 200 may include additional servers, clients, and other devices that are not shown.

In the depicted example, data processing environment 200 may be the Internet. Network 210 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 200 also may be implemented as a number of different types of networks, such as for example, an intranet, a local area network (LAN), or a wide area network (WAN). FIG. 2 is intended as an example, and not as an architectural limitation for the different illustrative embodiments.

Among other uses, data processing environment 200 may be used for implementing a client server environment in which the embodiments may be implemented. A client server environment enables software applications and data to be distributed across a network such that an application functions by using the interactivity between a client data processing system and a server data processing system. Data processing environment 200 may also employ a service oriented architecture where interoperable software components distributed across a network may be packaged together as coherent business applications.

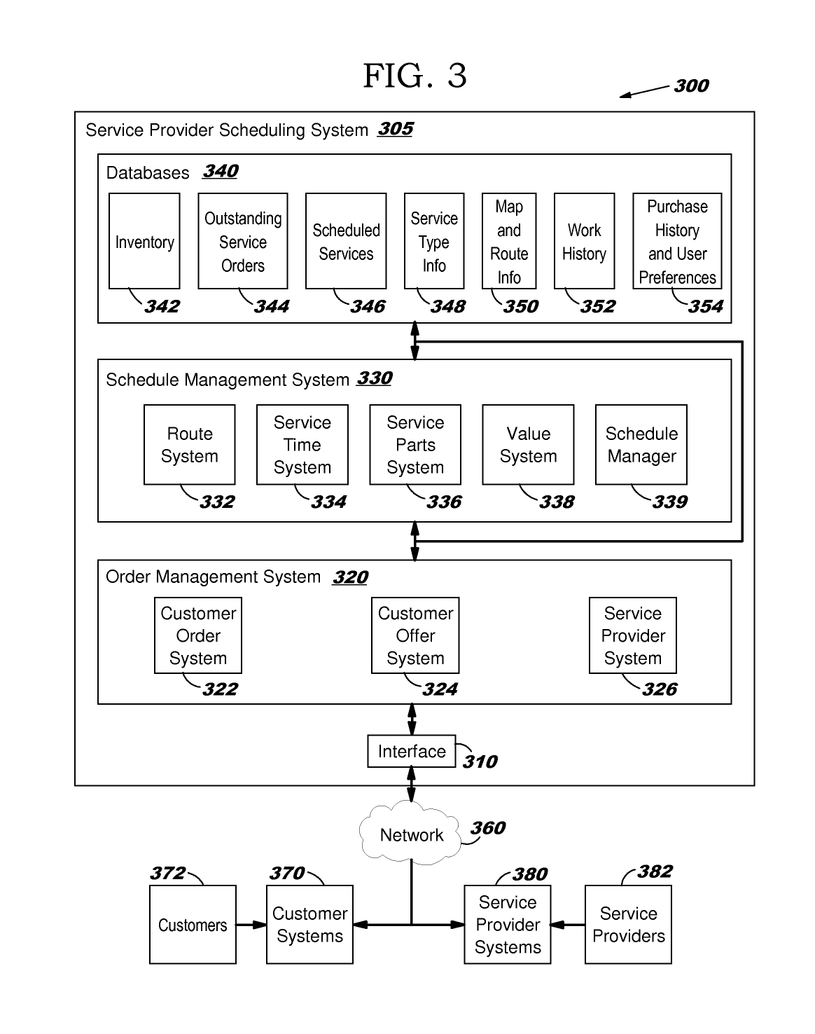

FIG. 3 is a block diagram of a service provider scheduling management system 300 in which various embodiments may be implemented. A service provider scheduling system 305 communicates across a network 360 with customer systems 370 and service provider systems 380 for allowing customers 372 to order services, to make service offers to customers 372 and for communicating with service providers 382 regarding scheduled services. Service provider scheduling system 305 may be implemented on a single server, multiple servers or even in a cloud implementation. Network 360 may be the internet or other communication network such as a cellular network. Customer systems 370 and service provider systems 380 may be desktop computers, laptops, tablets, smart phones, or other user communication devices such as landline phones. Communications may be by voice, text, email, webpage, mail, etc.

Service provider scheduling system 305 includes a user interface 310, an order management system 320, a schedule management system 330, and databases 340. User interface 310 communicates with customer systems 370 and service provider systems 380 across network 360. User interface 310 also communicates with order management system 320 in obtaining and providing information about services and schedules to customers 372 and service providers 382. Order management system 320 utilizes schedule management system 330 for determining possible appointments for performing services and relative values of those appointments. Order management system 320 with schedule management system 330 also utilize databases 340 to offer and sell services through user interface 310, including offering discounts or other incentives for selling multiple products or services in navigationally proximate locations. Order management system 320 also utilizes databases 340 to provide service schedules for service providers 382 as well as to accept input from the service providers such as information regarding services provided and time taken, whether a follow up visit is needed, whether additional items may be needed in the follow up visit, whether the service provider vehicle has encountered mechanical issues causing a delay, etc.

Order management system 320 includes a customer order system 322, a customer offer system 324 and a service provider system 326. Customer order system 322 receives requests for services from customers 372 and schedules appointments with those customers to fulfill those service requests. This can include customer order system 322 providing one or more appointments for the customer to select including providing discounts or other incentives for appointments at preferred times. Options for appointments and their relative values may be obtained from schedule management system 330. Customer offer system 324 identifies potential customers for services that are geographically proximate to an upcoming service appointment, and then contacts those potential customers with offers or other incentives to perform services for those geographically proximate customers. Service provider system 326 provides a list scheduled appointments for service providers with needed inventory for those appointments. Service provider system also accepts input from the service providers such as information regarding services provided and time taken, whether a follow up visit is needed, whether additional items may be needed in the follow up visit, whether the service provider vehicle has encountered mechanical issues causing a delay, etc.

Schedule management system 330 includes a route system 332, a service time system 334, a service parts system 336, and a value system 338. These systems are managed by a schedule manager 339. Schedule management system 330 receives requests for service for certain geographic locations and then provides a set of recommended appointment times with expected values for each appointment. Potential customers can also be identified.

Route system 332 calculates the time needed for a service provider to travel to from a home base to a customer, or from a first customer to a second customer, for providing a service to that customer. Given a set of customers for a service provider, route system can also provide an optimized route to visit each customer. Route system 332 can also be utilized to identify other potential customers that are navigationally proximate to an existing customer. The proximity may be in terms of a geographic distance from the first customer address or a route distance to the first customer. The proximity may also be in terms of a travel time from the first customer address or route to the first customer. Other forms of proximity may also be utilized as well. Collectively, these types of proximity are referred to herein as navigationally proximate. That is, two customers are navigationally proximate if a service provider can be reasonably expected to drive to both customers within a reasonable period of time.

Service time system 334 can provide an expected amount of time needed to perform certain services. For example, a plumber replacing a hot water heater is expected to take a certain amount of time to replace that hot water heater depending on the size of the hot water heater, whether the hot water heater is gas or electric, and the general location of the hot water heater (e.g. attic, interior closet, or exterior closet). Service parts system 336 can provide a set of recommended tools, parts or other supplies for performing the service. In the example of the hot water heater, the plumber needs a new hot water heater of the size and efficiency requested by the customer, tools to remove the existing hot water heater, tools, parts or supplies to install the new hot water heater, as well as a set of optional tools, parts or other supplies which may be needed in certain situations (e.g., additional water and gas pipe and fittings should excessive corrosion be found).

Value system 338 determines a value for a given route and service appointment based on a variety of information. For example, value system 338 can provide an expected value for a requested service given the type of service to be performed, the time expected to perform that service, the supplies needed for that service, the route distance and time to reach the customer from another appointment and to travel to the next customer, the billing rate of the service provider, the efficiency of the service provider for the type of service requested, the cost of the service provider (or providers if multiple providers are needed to perform the service), etc. Much of this information is obtained from the other systems of schedule management system 330 as well as from databases 340. Additional information may be utilized such as lost opportunity costs, regional preference factors, near term factors, as well as statistical analysis of probabilities for cancellations and other anomalies. Alternatively, travel distance and the value thereof may be utilized instead of travel time.

Schedule manager 339 manages the interaction of the systems and databases to provide a set of recommended appointment times for a requested service by a customer or for a set of potential customers. This information is then used by customer order system 322 for a requesting customer, by customer offer system 324 for contacting potential customers, and by service provider system 326 to provide a list of scheduled services including a supplies list for the service providers. Schedule manager 339 can also assist in determining the service needed by a customer given a set of issues or problems.

Order management system 320 and schedule management system 330 utilize databases 340 located in service provider scheduling system memory for assisting in the service scheduling process. That is, these databases store information utilized by order management system 320 and schedule management system 330. These databases include an inventory 342, outstanding service orders 344, scheduled services 346, service type information 348, map and route information 350, work history 352, and purchase history and user preferences 354. Inventory 342 includes a current list of all services available, the tools, parts or other supplies needed or recommended to perform those services, whether those tools, parts or other supplies are in a warehouse or on a service provider vehicle, etc. This is important to maintain to avoid scheduling services where the appropriate tools, parts or other supplies needed are not available. Inventory 342 can include whether an item is allocated for a future service appointment but is still in warehouse inventory awaiting the service provider to pick it up from the warehouse.

Outstanding service orders 344 includes a list of service requests pending scheduling. This can include the service requested, the customer name and location, references to supplies needed in or missing from inventory, etc. Outstanding service orders 344 can be utilized to help identify delivery routes that can include more services as well as customers that may be contacted for additional services or appointment time adjustments as needed. Outstanding service orders 344 is also utilized to prepare a set of service requests for preparing appointments at the appropriate time (such as when the needed supplies are in inventory).

Scheduled services 346 includes a list of services scheduled including references to the service provider and vehicle or type of vehicle utilized for each service. This can also include information regarding the route to be taken for determining whether a potential customer may be navigationally proximate to an existing scheduled route.

Service type information 348 includes information regarding the types of services which can be performed and the tools, parts or other supplies needed to perform these services. Also included are experience and credential requirements for any service providers to perform the services. For example, replacing an electric water heater requires some experience with electrical components and replacing a gas water heater requires some experience with gas components. Additional information such as a severity or emergency rating may be included in this database. For example, a repair of a gas leak may be considered an emergency and require immediate attention.

Map and route information 350 includes information regarding the locale where services may be scheduled. This can include a map of the locale, distances, expected travel times (which may vary by time of day), road construction, etc. The level of detail and breadth may vary significantly depending on order management system 320 and schedule management system 330. For example, if products are sold to customers nationwide (or even internationally), then a very large database may be utilized. Third party products may be utilized including those that may be accessible across the internet.

Work history 352 includes a work history for each service provider. This allows the system to determine the qualifications, experience and efficiency of each service provider for each type of service provided. This can also include information regarding positive and negative customer feedback for a given provider and customer. For example, if a customer has a negative experience with a service provider, then a different service provider should be sent to that customer for future service requests. Additional information about each provider may be stored such as qualifications, regional preferences, and other information helpful in assigning the service provider to customers.

Purchase history and user preferences 354 includes information about various stated user preferences such as whether the user prefers certain appointment times and days, credit card information, etc. It can also include preferences and other attribute information about a user such as income level, whether the user owns pets, is married, etc. that may be obtained from third parties. Purchase history with user preferences 354 also include historical information regarding prior purchases including observed trends and other analytics for use as described below.

Alternative embodiments may utilize alternative database configurations. For example, schedule management system 330 may include additional systems or a single system for various functions. Order managements system 320 may also be combined with user interface 310. Databases 340 may be combined in alternative configurations, such as separating purchase history and user preferences 354 into two separate databases. Additional or different information may be collected and stored for use in each database.

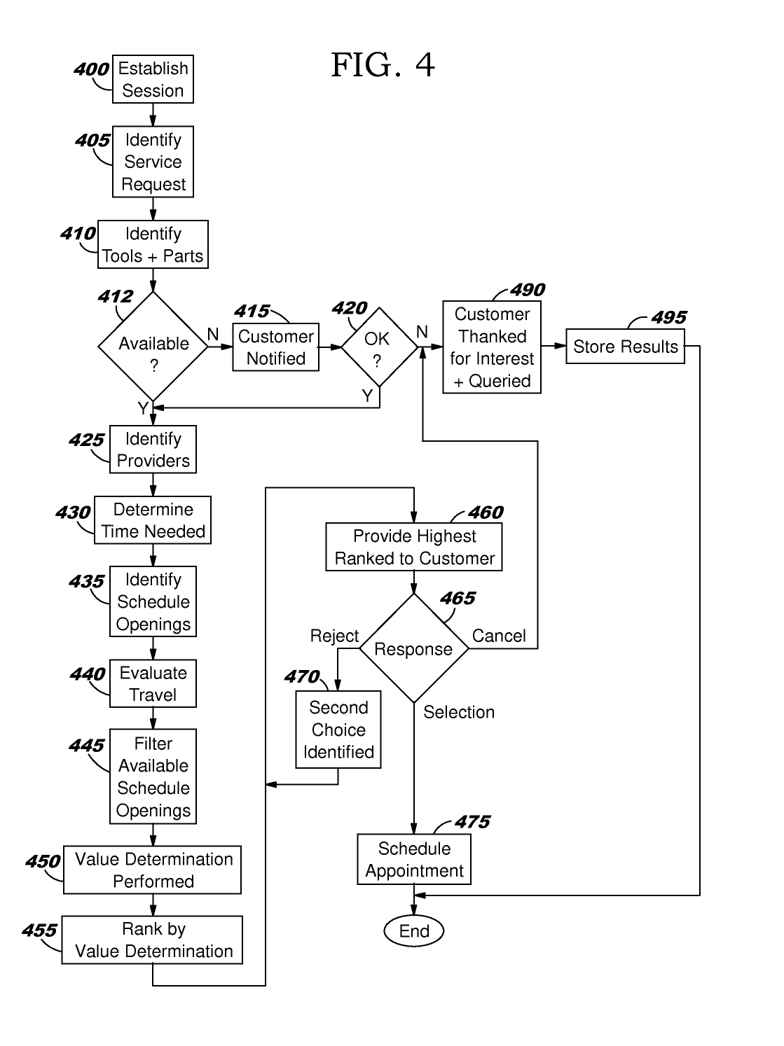

FIG. 4 is a flow diagram of a customer requesting a service appointment in which various embodiments may be implemented. This embodiment is described with reference to the system configuration of FIG. 3, although this embodiment could be implemented with alternative system configurations. In this embodiment, the customer 372 has established a communication session through customer system 370 with customer order system 322. This may be through a website, a telephone call to a voice activated system, or even to an operator which is on the customer order system. Alternative embodiments may utilize many types of communication tools to implement this embodiment or other embodiments.

In a first step 400, the customer establishes the communication session, which includes identifying the customer and the customer's address (i.e. location) where the service is to be performed. If the customer is a preexisting customer in purchase history database 354, then a user identifier and a password may be used. If the customer is new, then an account may be established in customer history database 354 including customer identifying information, such as the customer's name, as well as the address/location where the service is to be performed. In case the customer has multiple locations (e.g., home and business) then the customer will identify the desired address for the service. Customer preferences may also be obtained from database 354 or acquired from the customer and added to database 354. In a second step 405, the customer identifies the requested service as well as information helpful to determine the parameters of that service including customer timing requirements (e.g., an emergency so as soon as possible, Thursday afternoon, etc.). For example, the user may request that cable television be installed in their home. This should include the number of outlets requested, whether the house is pre-wired, etc. The customer may simply describe the problem or issue for analysis to determine what the issue may be. For example, the customer may have a drop in water pressure, but not know the reason why. Some questions may be asked of the customer, such as whether the drop in pressure was sudden or incremental, to narrow the possible number of services that may be needed. Schedule manager 339 can assist in this process.

The exact type of service may not be discernible from the customer. Often the service may begin with a professional on-site evaluation and diagnosis. This can be followed by one or more services provided based on that diagnosis. However, an expected set of possible services may be discernable using statistical analysis based on prior experience. For example, a leak in the ceiling could be caused by a leaking pipe, a hot water heater leak, an A/C unit drip pan overflow, etc. This set of possible services can be predicted using statistical analysis including an expected amount of service time to perform the service, service provider qualifications needed to perform the service, and an expected fee for those services. The appropriate tools, parts or other supplies can also be predicted. Of course, if the actual service differs substantially, a second follow up service may need to be scheduled when that is determined.

Once the customer has been identified and the service requested has been identified, then in step 410 the tools, parts or other supplies needed for the service are identified by the service parts system 336 using service type information database 348 including determining whether the appropriate supplies are available in inventory 342. If the appropriate supplies not currently available, then it is determined when the supplies could be obtained. These tools, parts or other supplies may be located in a warehouse, a service provider vehicle, or even a third party provider. In step 412, if the tools, parts or other supplies are currently available or available in a reasonable time (e.g., 48 hours or so depending on the type of service needed), then processing continues to step 425, otherwise processing continues to step 415. In step 415, the customer is told that the service cannot be performed until the date that the tools, parts or other supplies could be obtained and the customer is asked in step 420 whether the customer is willing to wait until that time or not. If yes, then processing continues to step 425, otherwise processing continues to step 490 below.

In step 425, the appropriate service providers with the necessary qualifications and inventory to perform the requested services are identified. This can include identifying which of the service providers service the region where the customer is located, whether the service providers have an inventory needed to perform the service (either in the vehicle or readily available), and whether any of the service providers has a prior good or bad history with this customer from work history database 352. The result of this analysis is a list of qualified service providers suitable for performing the requested task for this customer at this address. Then in step 430, the amount of service time needed for each identified service provider to perform the requested service is calculated. The amount of time may vary depending on the type of service as well as the qualifications and efficiency of the service provider. This can be performed by service time system 334 using service type information database 348 and work history database 352. A reasonable time buffer can also be determined with this analysis. That is, some service tasks may have large variances in time needed and other service tasks may have small variance. In addition, some service providers may be more consistent than others in performing certain services within a given period of time.

Then in step 435, all schedule openings for these identified providers that are sufficiently long to perform the requested service with a reasonable buffer and within a reasonable time frame while meeting customer timing and location requirements are identified from scheduled services database 346. The reasonable time frame may be predetermined to a fixed time frame (e.g., within three days of the current date) or it may vary depending on the type and severity of the requested service or other timing requirements of the user. The timing of obtaining the appropriate tools, parts or other supplies are also taken into account. For example, if the supplies have to be ordered and will not be available for 24 hours, then no appointment will be scheduled prior to the time to obtain the supplies and have them picked up by a service provided. Additional requirements by the customer or preexisting customer preferences may also be taken into account (e.g., the customer may not be available in the mornings, or the service provider must be able to speak a certain language for communicating with the customer).

In step 440, each identified schedule opening is evaluated for travel distance and time from the previous appointment to the customer location and then to the next appointment. This can include travel distance and time needed to pick up parts, tools and other supplies if needed. Alternatively, travel distance and an average value thereof may be utilized instead of travel time. This evaluation can be performed by route system 332 using map and route information database 350. Then in step 445, the identified scheduled openings are then filtered to remove those without sufficient time to travel to and from the customer and also perform the services with a reasonable buffer. That is, if there is not sufficient time to travel to a schedule opening (including picking up any tools, parts or other supplies needed), perform the service, and travel to the next appointment with a reasonable buffer, then that schedule opening is removed from the list of schedule openings. Other filters or requirements may also be performed at this time such as load balancing requirements between service providers.

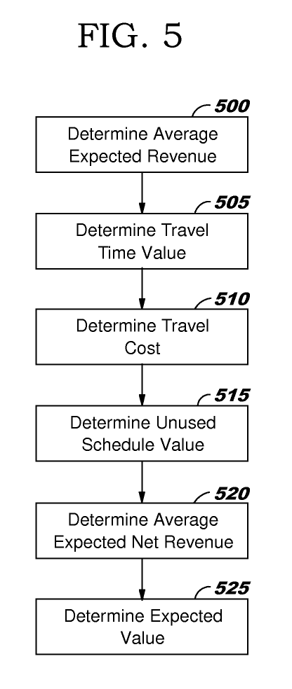

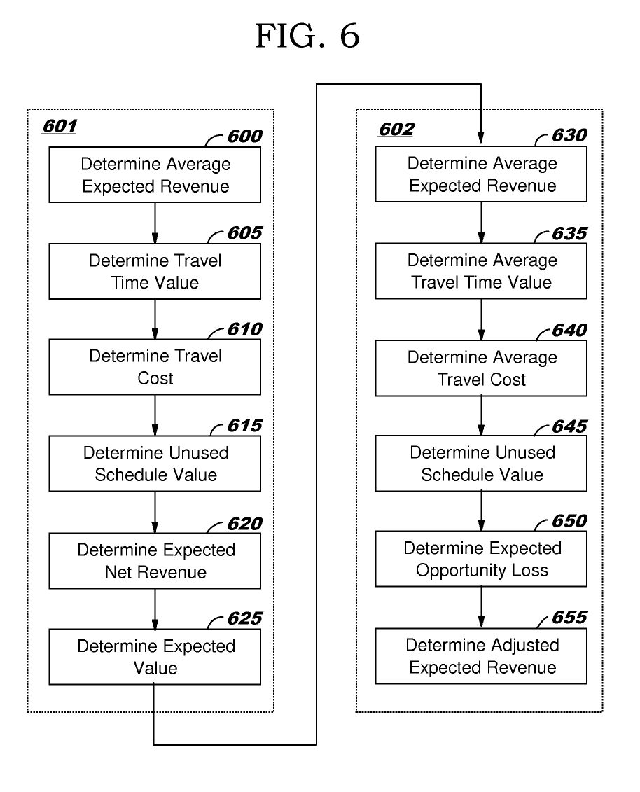

Then in step 450, a value determination is performed for each of the filtered schedule openings by value system 338. The value determination is used to provide a relative value of each provider performing the requested service within each filtered schedule opening for optimization purposes. The value determination may also be utilized to determine a price charged for the service. Alternatively, all services may have fixed prices based on the type of service provided. Embodiments showing implementations of the value determination are described below with reference to FIGS. 5 and 6. Processing then continues to step 455 where the scheduled openings are ranked by value. That is, those with the highest value are ranked higher as they provide the optimal value. Scheduled openings that do not meet a predetermined threshold value or percentage may be removed from the rankings. That is, a scheduled opening which would not provide a sufficient return may be removed from the ranking list and not offered to the customer.

The customer is then offered the highest ranked or optimal schedule opening(s) (i.e., appointment) to choose from in step 460. This may be a single choice provided to the customer or a set of choices. The customer also has the opportunity to reject all appointment choices provided or to cancel the service request. If a scheduled opening is of particular value, an incentive may be offered to the customer to accept that scheduled opening. This incentive may be a discount, an award, and extended warranty, or other incentive to encourage the customer to accept the high value scheduled opening. Then in step 465, a response is received from the customer. If the customer choice is a cancellation of the service request, then processing continues to step 490. If the customer choice is a rejection of the offered schedule openings, then processing continues to step 470 where a second choice or set of choices is identified based on the earlier rankings and processing returns to step 460 to display those new choices to the customer. If the choice is of a selection of a provided scheduled opening in step 465, then processing continues to step 475.

In step 475, the selected schedule opening is scheduled as an appointment by updating scheduled services 346 and purchase history 354. Inventory 342 may also be updated based on tools, parts and other supplies allocated for the scheduled appointment. If tools, parts or other supplies need to be ordered, then they are ordered in this step. Processing may then proceed to other processes described below, or may simply cease until the next request for services.

In step 490, the customer has cancelled the request for services without setting an appointment from either step 420 or step 465. In step 490, the customer is thanks for their interest in services and may be asked for a reason for not accepting the offer to make an appointment, particularly if the customer cancelled after receiving proposed schedule openings. This information is then stored in purchase history and user (also referred to as a customer) preferences 354 for future reference in step 495. Processing then ceases until the next request for services from a customer.

Alternative embodiments may perform the same or similar processes in a different order or approach. For example, filtering providers based on customer preferences may be performed in step 425. In another example, a base value determination may be determined for each scheduled appointment and stored with that appointment in the scheduled services database. Each base value determination can then be updated based on new information in step 450. Many other such alternative embodiments may be utilized as appreciated by one of ordinary skill in the art.

FIG. 5 is a flow diagram of a value determination for a possible schedule appointment in accordance with a first embodiment. This value determination is a relative value of performing a requested service at a specific scheduled time at a designated address by a set of identified service providers with current service schedules, which can be identified through the process described in FIG. 4.

In steps 500 through 525, an expected value of a schedule opening is determined for each of the set of service providers. This is a value based on statistical analysis of the work history of the service providers weighted with an average of other service providers. This determination starts with an expected net revenue which is equal to the expected revenue minus the value of travel time and the cost of travel minus the value of any unused remainder of the open schedule that cannot be used for other appointments. This expected net revenue can then be multiplied by a probability of occurrence to generate an expected value of the schedule opening. An example is provided for illustrative purposes with service providers A and B each having a $60 hourly rate, a two hour schedule opening, and a $0.56 travel cost per mile. This is combined with a statistically expected appointment time of 1.5 hours for the requested service type for each service provider and an expected additional travel time of 15 minutes for an expected additional distance of 7.5 miles based on where A is located prior to and subsequent to the schedule opening and an expected additional travel time of 10 minutes for an expected additional distance of 5.1 miles based on where B is located prior to and subsequent to the schedule opening.

In step 500, the expected revenue can be determined as an expected appointment time for the service requested by the customer multiplied by the rate charged by each service provider. For example, given the expected appointment time is 1.5 hours and the hourly rate of the service provider is $60 per hour for both A and B, then the expected revenue is $90 for both A and B.

Then in step 505, the value of travel time can be determined as the expected additional time travelled for an appointment by the service provider to the customer location based on the prior appointment and the subsequent appointment of the service provider multiplied by the expected hourly rate of the service provider. Given the expected additional time travelled is 15 minutes for A and using A's hourly rate of $60, then the value of travel time is $15 for A. Given the expected additional time travelled is 10 minutes for B and using B's hourly rate of $60, then the value of travel time is $10 for B. In step 510, the expected cost of travel can be determined as the expected additional service call distance times the expected cost per mile. Given the expected additional service call distance is 7.5 miles for A and 5.1 miles for B and the expected cost per mile is $0.56 per mile, then the expected cost of travel is $4.20 for A and $2.86 for B.

Then in step 515 the value of any unused remainder of the open schedule can be determined as the amount of time remaining in the schedule opening (so long as it is less than a predetermined threshold such as 30 minutes) multiplied by the expected hourly rate. Given the scheduled opening was for two hours minus the expected appointment time of 1.5 hours minus the expected time travelled of 15 minutes for A and 10 minutes for B leaves 15 minutes remaining that is unused for A and 20 minutes for B. That can be multiplied by the expected hourly rate of $60 to determine a value of the unused remainder at $15 for A and $20 for B. Combining these values in step 520 results in an expected net revenue of ($90−15−4.2−15) or $55.80 for A and ($90−20−2.86−10) or $57.14 for B in this example.

The expected value is then calculated in step 525 by multiplying the expected net revenue with a probability of occurrence, which is the likelihood for the appointment to actually be performed (e.g., not cancelled). For example, an appointment may be cancelled by the requesting customer for a variety of reasons or the service provider may not be able to make the scheduled appointment due to a vehicle breakdown or other issue. This probability can be determined statistically using a variety of factors such as the type of service requested, prior history of the customer, reliability of the service provider's vehicle, etc. In the present example, if there is a 90 percent statistical likelihood that service provider A will be able to perform the requested service for the customer in the proposed time slot, then the expected value of the appointment is $55.80*0.90=$50.22. Also, if there is a 90 percent statistical likelihood that service provider B could obtain an appointment for this two hours schedule opening, then the expected value of B's schedule opening is $57.14*0.90=$51.43. At this point, it would seem apparent that the appointment should be assigned to service provider B as B's expected value is higher. However, this is not taking into account the possibility of B obtaining another service request for that same schedule opening at a later time, which is explained below with reference to FIG. 6.

FIG. 6 is a flow diagram of a value determination for a possible schedule appointment in accordance with a second embodiment. This value determination is a relative value of performing a requested service at a specific scheduled time at a designated address by a set of identified service providers with current service schedules.

In a first set of steps 601 including steps 600 through 625, an expected value of a schedule opening is determined for each of the set of service providers. This is a value based on statistical analysis of the work history of the service providers weighted with an average of other service providers. This determination starts with an expected net revenue which is equal to the expected revenue minus the value of travel time and the cost of travel minus the value of any unused remainder of the open schedule that cannot be used for other appointments. This expected net revenue can then be multiplied by a probability of occurrence to generate an expected value of the schedule opening. An example like that shown in FIG. 5 above is provided for illustrative purposes with service providers A and B each having a $60 hourly rate, a two hour schedule opening, and a $0.56 travel cost per mile. This is combined with a statistically expected appointment time of 1.5 hours for the requested service type for each service provider and an expected additional travel time of 15 minutes for an expected additional distance of 7.5 miles based on where A is located prior to and subsequent to the schedule opening and an expected additional travel time of 10 minutes for an expected additional distance of 5.1 miles based on where B is located prior to and subsequent to the schedule opening.

In step 600, the expected revenue can be determined as an expected appointment time for the service requested by the customer multiplied by the rate charged by each service provider. For example, given the expected appointment time is 1.5 hours and the hourly rate of the service provider is $60 per hour for both A and B, then the expected revenue is $90 for both A and B.

Then in step 605, the value of travel time can be determined as the expected additional time travelled for an appointment by the service provider to the customer location based on the prior appointment and the subsequent appointment of the service provider multiplied by the expected hourly rate of the service provider. Given the expected additional time travelled is 15 minutes for A and using A's hourly rate of $60, then the value of travel time is $15 for A. Given the expected additional time travelled is 10 minutes for B and using B's hourly rate of $60, then the value of travel time is $10 for B. In step 610, the expected cost of travel can be determined as the expected additional service call distance times the expected cost per mile. Given the expected additional service call distance is 7.5 miles for A and 5.1 miles for B and the expected cost per mile is $0.56 per mile, then the expected cost of travel is $4.20 for A and $2.86 for B.

Then in step 615 the value of any unused remainder of the open schedule can be determined as the amount of time remaining in the schedule opening (so long as it is less than a predetermined threshold such as 30 minutes) multiplied by the expected hourly rate. Given the scheduled opening was for two hours minus the expected appointment time of 1.5 hours minus the expected time travelled of 15 minutes for A and 10 minutes for B leaves 15 minutes remaining that is unused for A and 20 minutes for B. That can be multiplied by the expected hourly rate of $60 to determine a value of the unused remainder at $15 for A and $20 for B. Combining these values in step 620 results in an expected net revenue of ($90−15−4.2−15) or $55.80 for A and ($90−20−2.86−10) or $57.14 for B in this example.

The expected value is then calculated in step 625 by multiplying the expected net revenue with a probability of occurrence, which is the likelihood for the appointment to actually be performed (e.g., not cancelled). For example, an appointment may be cancelled by the requesting customer for a variety of reasons or the service provider may not be able to make the scheduled appointment due to a vehicle breakdown or other issue. This probability can be determined statistically using a variety of factors such as the type of service requested, prior history of the customer, reliability of the service provider's vehicle, etc. In the present example, if there is a 90 percent statistical likelihood that service provider A will be able to perform the requested service for the customer in the proposed time slot, then the expected value of the appointment is $55.80*0.90=$50.22. Also, if there is a 90 percent statistical likelihood that service provider B could obtain an appointment for this two hours schedule opening, then the expected value of B's schedule opening is $57.14*0.90=$51.43.

At this point, it would seem apparent that the appointment should be assigned to service provider B as B's expected value is higher. However, this is not taking into account the possibility of B obtaining another service request for that same schedule opening at a later time. That is, before accepting a service request to fill a schedule opening, a service provider may consider whether there is a strong likelihood of a more lucrative service request for that same schedule opening in the future. Lost opportunity costs can also be calculated and utilized for comparative purposes between multiple service providers of a service organization as described below.

In a second set of steps 602 including steps 630 through 655, an adjusted expected value of a schedule opening is determined. This is a value based on a requested service from a customer at a given location adjusted for lost opportunity cost which is based on a statistical probability that another possible appointment will be missed due to taking this appointment. This probability can be determined statistically using a variety of factors such as the location of the service provider at the prior appointment (if the prior appointment is in a remote area then there is a low likelihood of a nearby service request), the size of the schedule opening (a larger schedule opening provides more time for the service provider to travel to another location), the date of the schedule opening (certain days may be more likely to have service requests), the proximity of the date of the schedule opening (there is less time to receive a service request today than for two days from today), etc. Other factors can include how highly rated the service provider is, how efficient that service provider is (more types of services can be performed within a given time period), etc.

In this embodiment, the lost opportunity cost starts with an average expected net revenue which is equal to an average expected revenue for all service types minus the value of average travel time and the cost of average travel minus the value of any average unused remainder of the open schedule that cannot be used for other appointments. A supplemental example is provided using the same service providers A and B each having a $60 hourly rate, a two hour schedule opening, and a $0.56 travel cost per mile. This is combined with a statistical average appointment time for all service types of 1.3 hours and an average extra travel time of 30 minutes for an average distance of 15 miles for A based on A's prior and subsequent appointment types and locations and an average travel time of 15 minutes for an average distance of 8 miles for B based on B's prior and subsequent appointment types and locations.

In step 630, the expected revenue can be determined as an average appointment time for this type of service call multiplied by the hourly rate charged by the service provider. For example, given the average appointment time for this type of service call is 1.3 hours (assuming A and B have the same or similar efficiency) and the expected hourly rate of the service provider is $60 per hour for both A and B, then average expected revenue is $78 for both A and B. Then in step 635, the value of travel time can be determined as the projected time to be travelled for the appointment multiplied by the expected hourly rate of the service provider. Given the projected time travelled is 30 minutes for A and using the expected hourly rate of $60, then the value of travel time is $30 for A. Given the projected time travelled is 15 minutes for B and using the expected hourly rate of $60, then the value of travel time is $15 for B. In step 640, the expected cost of travel can be determined as the projected service call distance times the expected cost per mile. Given the projected service call distance is 15 miles for A and 8 miles for B and the expected cost per mile is $0.56 per mile, then the expected cost of travel is $8.40 for A and $4.48 for B. Then in step 645 the value of any unused remainder of the open schedule can be determined as the amount of time remaining in the schedule opening (so long as it is less than a predetermined threshold such as 30 minutes) multiplied by the expected hourly rate. Given the scheduled opening was for two hours minus the average expected appointment time of 1.3 hours minus the projected time travelled of 30 minutes for A and 15 minutes for B leaves 12 minutes remaining that is unused for A and 27 minutes for B. That can be multiplied by the expected hourly rate of $60 to determine a value of the unused remainder at $12 for A and $27 for B. Combining these values in step 650 results in an expected opportunity loss of ($78−30−8.40−12) or $27.60 for A and ($78−15−4.48−27) or $31.52 for B in this example.

The expected opportunity losses are then subtracted from the expected value of the requested services to provide the adjusted expected revenue in step 655. In the example described above, the adjusted expected revenue would be ($50.22−$27.60) or $22.62 for A and ($51.43−$31.52) or $19.91 for B.

As described in FIG. 4 above, the adjusted expected values for the schedule openings of the various service providers are then compared. In the present example, A would be given the appointment because A has a higher adjusted expected value than B, even though B has a higher expected value when not taking into account lost opportunity costs. That is, B is more likely to fill the requested time slot with a valuable future customer request than A, so it is better to assign the service request to A from an overall increased overall net revenue perspective. In addition, from a purely short term monetary perspective, it may be better for B to reject the service request if the adjusted expected revenue was negative because on average B would receive another service request with a higher expected revenue. The adjusted expected value is not the expected revenue, but is a predicted extra amount that the service provider would receive by accepting the current service request as compared to not accepting the current service request. This is a statistically based determination and is only as good as the underlying data supporting that determination. However, it is a comparison suitable for use in determining which service provider should accept a service request. If all of the adjusted expected values are negative, then turning down the requested service may be considered as better opportunities may be forthcoming statistically. However, doing so could have other consequences such as a lost future customer plus negative publicity. Alternatively, the cost of the service could be increased for that customer to the point where the adjusted expected value is positive.

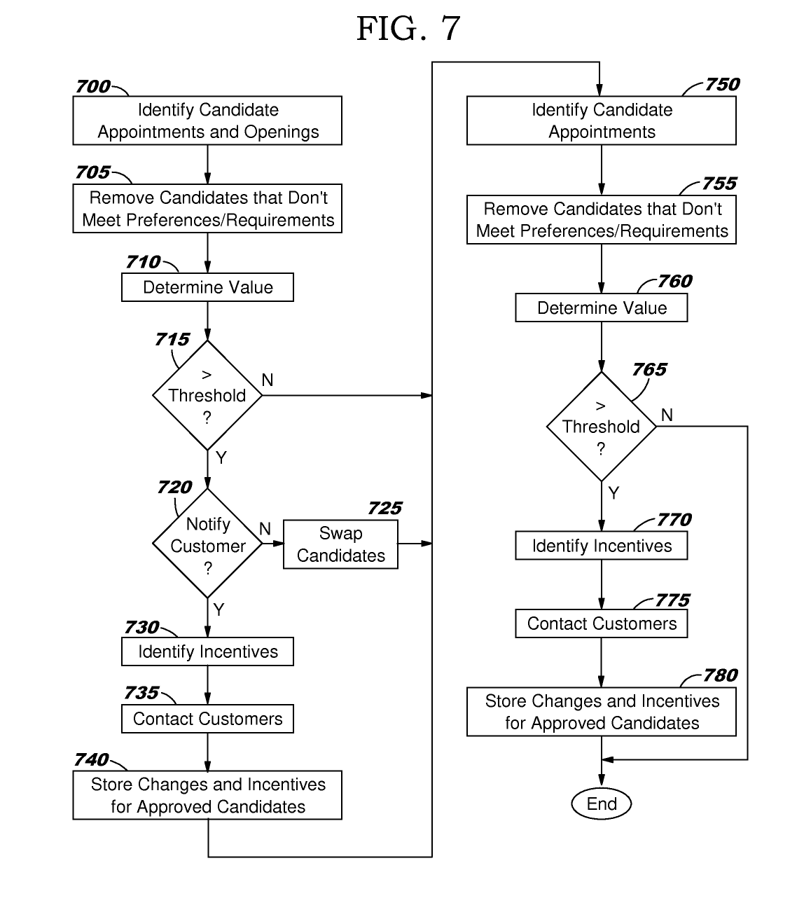

FIG. 7 is a flow diagram for proposing changes in scheduling of appointments in which various embodiments may be implemented. This is to optimize current schedules of appointments and may also be utilized when scheduling a new appointment in response to a service request. This process may be performed periodically, such as every night in the middle of the night or continuously, such as when a new service request is received.

In a first step 700, the locations of a set of scheduled appointments of scheduled services 346 are reviewed by schedule manager 339 for each service provider for a given day to identify candidate reordering of appointments or swapping of appointments between service providers. Appointments may also be swapped for schedule openings of another service provider. For example, if the route taken for a provider is inefficient, then a modification may be an improvement. That is, if a service provider drives a much longer distance than if his route was reorganized, then it may be worthwhile to reorganize his or her route. Also, if the routes of two service providers cross each other or if there is an outlier appointment from each service provider that is close to the route of another service provider, then an appointment swap may be appropriate. From this process, a set of candidate appointments are identified for possible swapping for a certain service provider or between service providers.

Then in step 705, the set of candidate appointments and openings for swapping are reviewed by schedule manager 339 to determine whether the possible swapping would still meet the customer preferences and requirements as stored in purchase history and user preferences 354 as well as to determine whether the service providers have the necessary skills, tools, or other capabilities necessary to perform the swapped appointment as stored in service type information 348 and work history 352. All those appointments (and any appointments which may be swapped for those appointments) that do not meet these requirements and capabilities are removed from the list of candidate appointments.

A value determination is then performed by value system 338 for each of the remaining list of candidate appointments for swapping in step 710. This results in a value of the swap. For example, if the expected value of each appointment increases by $2 each if swapped, then the value of the swap is $4. If appointments are being swapped, the value determination described in FIG. 5 may be more appropriate embodiment to utilize. However, if an appointment is being swapped for a schedule opening, then the value determination described in FIG. 6 may be more appropriate to be utilized. Based on these value determinations, then in step 715 it is determined whether any of the appointments and/or schedule opening should be swapped (the value of swapping is greater than zero or greater than a predetermined threshold). If yes, then processing continues to step 720, otherwise processing continues to step 750.

In step 720, it is determined whether the remaining appointments and/or schedule openings are swapped without notification of the customer or not. If there is no change in time and the customer was not told of a specific service provider when the appointment was made, then no notification of the customer is needed. If no notification is needed, then in step 725 the swap is performed and processing continues to step 750. Otherwise, processing continues to step 730. This process assumes that no notification of and approval from the service providers is required. However, if it is required, then the necessary processes could be implemented for that purpose similar to the processes described herein for the customers.

In step 730, possible incentives are identified for the customers that are to be requested to approve the change of service provider or change of appointment time. This can occur while each customer is being notified or may be performed beforehand to be used if needed. The incentives need to be less than the value of swapping or a predetermined percentage of the value of swapping or other threshold. These incentives can be determined from a known set of incentives, from user preferences, and from the prior history of the customer. For example, one customer may prefer frequent flyer miles for a certain airline, while another customer may have previously accepted a discount on the service to be provided. Of course, in some cases, no incentives may be approved due to the low value of swapping or due to the conditions which the appointment was provided (i.e., there may have been notification of possible changes within certain parameters). Then in step 735, the customers are contacted and requested to approve the modifications to their appointments. If needed, incentives may be provided to encourage the customer to approve. Finally in step 740, those appointments that are approved for swapping are exchanged and any incentives provided and accepted by a customer are stored in memory for providing to the customer when the service has been completed by the service provider and paid for by the customer. Processing then continues to step 750.

In step 750, candidate appointments for each service provider are identified which may be moved closer together to open space for another appointment. For example, if a service provider has 5 one hour appointments, each with 45 minutes between appointments (which totals 8 hours) but only 15 minutes travel time and slack time (for service time variability) needed between appointments, then the schedules may be compressed. By compressing the time between appointments to 15 minutes, and extra 2 hours is opened up for another appointment. In step 755, each candidate appointment is reviewed by schedule manager 339 to determine whether the possible movement of appointments would still meet the customer preferences and requirements as stored in purchase history and user preferences 354. Please note that this process assumes that no notification of and approval from the service providers is required. However, if it is required, then the necessary processes could be implemented for that purpose similar to the processes described herein for the customers.

In step 760, a value determination is then performed by value system 338 for each of the remaining list of candidate appointments. This results in a value of the schedule compression. Based on these value determinations, then in step 765 it is determined whether any of the appointments and/or schedule openings should be moved for compressing the schedule (i.e., the value of swapping is greater than zero or greater than a predetermined threshold). If yes, then processing continues to step 770, otherwise processing ceases,

In step 770, possible incentives are identified for the customers that are to be requested to approve the change of appointment time. This can occur while each customer is being notified or may be performed beforehand to be used if needed. The incentives need to be less than the value of schedule compression or a predetermined percentage of the value of schedule compression or other threshold. These incentives can be determined from a known set of incentives, from user preferences, and from the prior history of the customer. For example, one customer may prefer frequent flyer miles for a certain airline, while another customer may have previously accepted a discount on the service to be provided. Of course, in some cases, no incentives may be approved due to the low value of schedule compression or due to the conditions which the appointment was provided (i.e., there may have been notification of possible changes within certain parameters). Then in step 775, the customers are contacted and requested to approve the modifications to their appointments. If needed, incentives may be provided to encourage the customer to approve. Finally in step 780, those appointments that are approved for schedule compression are performed and any incentives provided and accepted by a customer are stored in memory for providing to the customer when the service has been completed by the service provider and paid for by the customer. Processing then ceases.

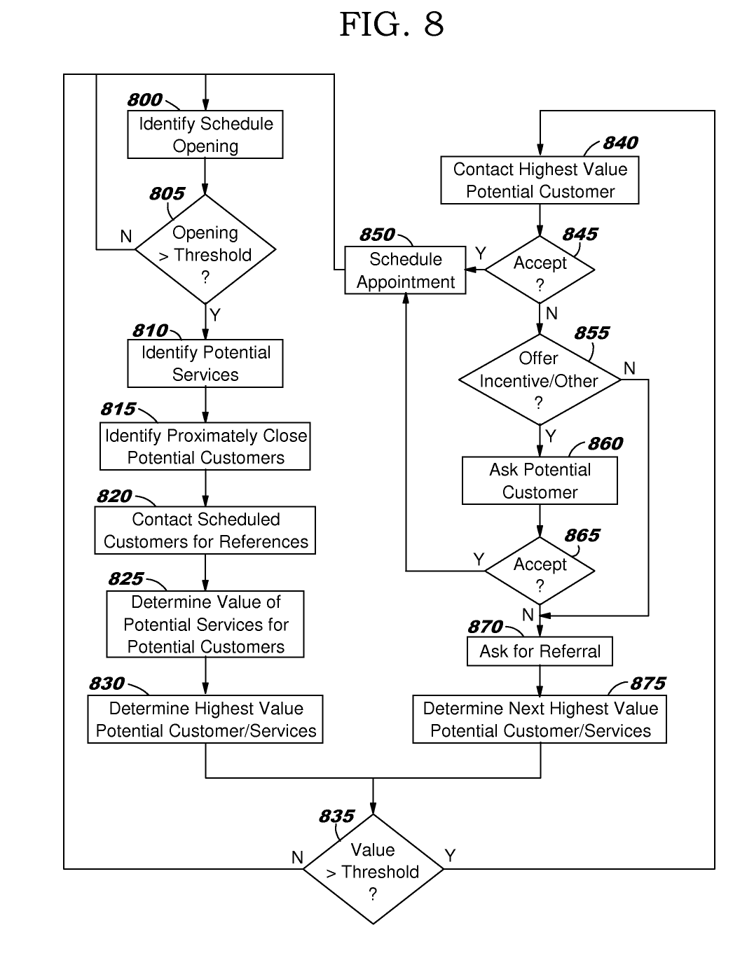

FIG. 8 is a flow diagram for providing offers for services to potential customers in which various embodiments may be implemented. In a first step 800, an opening in a provider's schedule is identified in scheduled services for any or a limited number of service providers. This can include an opening for a future date (within some predetermined date and time range) or a new or increased schedule opening created by a provider finishing a scheduled service early. This can also include a provider indicating that he or she will finish a service early in the near future, such as the service was completed earlier than expected or that a new service schedule may need to be scheduled for that customer due to unexpected issues that could not be completed in the currently scheduled appointment and subsequent schedule opening. Then in step 805, it is determined whether the identified schedule opening is greater than some predetermined threshold. For example, the minimum time to perform a service may be 45 minutes. If so, then the predetermined threshold may be set to 45 minutes or even an hour to allow for some extra time to travel to a new nearby appointment. If the schedule opening is less than the threshold amount, then processing returns to step 800 where additional schedule opening may be identified.

Then in step 810, a set of potential services are identified which could be performed in the identified schedule opening. This includes limiting those services which could be performed by the service provider with the schedule opening. For example, the service provider may not be qualified to perform certain services. For another example, the service provider may not have the needed tools or parts available to perform certain services, especially if the schedule opening is for the current day. In step 815, a set of known customers are identified as potential customers that are proximately close to a route from the prior customer to the subsequent customer (i.e., those customers immediately prior to and subsequent to the schedule opening) and which may be interested in any of the set of potential services. That is, from the database of known prior customers or otherwise identified potential customers are identified based on their location and potential interest in services. By being proximately close to a route from the prior customer to the subsequent customer (or close to either customer), a potential customer could be reached by the service provider in time to perform some of the determined set of services. Proximately close means that the customer is close in driving time to the currently planned or reasonably alternate route from the prior to the subsequent customer. Only those customers which might be interested in the set of services are considered. This can include looking at prior customer history and customer preferences. For example, a customer who recently had a certain annual service performed would not be interested in the same service at this time. However, if certain non-emergency issues were found during that annual service, this may be a good time to schedule follow up services to take care of those issues. Then in step 820, the prior and subsequent customers can be contacted to find out if they have any nearby friends or neighbors which may be interested in some services as potential customers. A standard incentive could be provided such as a referral price break or other similar incentive could be provided.

Then in step 825, value determinations are performed for each of the set of potential customers and set of potential services for the schedule opening. These value determinations could be performed as described above with reference to FIGS. 5 and 6. In step 830, the customer with the highest value (optimal) potential service is identified. Other potential services for the same customer are also identified which have a value within a percentage or other measure of the highest or optimal value service.

In step 835, it is determined whether the determined value exceeds a predetermined threshold. This is to prevent scheduling services which may have limited value to the service provider and his or her employer. Alternatively, the second embodiment of determining value may be utilized to compare the value of the potential service to other potential services which could be scheduled later. Other alternatives may utilize other value comparisons. If the determined value does not exceed the predetermined threshold, then processing returns to step 800 above to look for other schedule openings. Otherwise, processing continues to step 840.

In step 840, the potential customer is contacted to see if that customer is interested in the potential service (which was determined to have the highest or optimal value). If the potential customer accepts in step 845, then the appointment is scheduled in step 850 and processing returns to step 800. Otherwise, processing continues to step 855 where it is determined whether to offer an incentive to the customer or offer another potential service identified in step 830. This determination is based on the value of the potential services and whether an incentive may be worthwhile. If not, then processing continues to step 870, otherwise processing continues to step 860. In step 860, the customer of offered the incentive and/or alternative service. The in step 865, it is determined whether the potential customer accepted the incentive or alternative service. If yes, then processing returns to step 850 to schedule the appointment. If not, then processing continues to step 870. In step 870, the potential customer may be asked if he or she has any potential referrals. A standard incentive may be provided. Processing then continues to step 875 where a potential customer with the next highest value potential service is identified. Other potential services for the same customer are also identified which have a value within a percentage or other measure of the highest or optimal value service. Processing then returns to step 835.

Many other alternative embodiments could be implemented for identifying schedule openings, potential services for performing within the schedule openings, potential customers to be contacted for receiving those potential services, and incentives utilized for obtaining a service to be provided within the schedule openings.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

A data processing system suitable for storing and/or executing program code will include at least one processor coupled directly or indirectly to memory elements through a system bus. The memory elements can include local memory employed during actual execution of the program code, bulk storage media, and cache memories, which provide temporary storage of at least some program code in order to reduce the number of times code must be retrieved from bulk storage media during execution.

A data processing system may act as a server data processing system or a client data processing system. Server and client data processing systems may include data storage media that are computer usable, such as being computer readable. A data storage medium associated with a server data processing system may contain computer usable code such as for managing a service provider schedule. A client data processing system may download that computer usable code, such as for storing on a data storage medium associated with the client data processing system, or for using in the client data processing system. The server data processing system may similarly upload computer usable code from the client data processing system such as a content source. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

The terminology used herein is for the purpose of describing particular embodiments and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of optimizing a service provider schedule and route comprising:
receiving a service request from a customer, the service request including customer timing and location requirements;
retrieving, from a service information system, service timing and inventory for performing a service to fulfill the service request;
retrieving, from a scheduling system, a set of gaps in schedules that meet the customer timing and location requirements for a set of service providers which meet the service timing and inventory requirements, each schedule gap having a respective prior and subsequent location;
utilizing a processor to determine an optimal schedule appointment for a first one of the set of service providers to perform the service during a first one of the set of schedule gaps, the optimal determination including service timing;
transmitting an offer to the customer for the first service provider to perform the service to fulfill the service request during the optimal schedule appointment in the first schedule gap; and
responsive to receiving a confirmation from the customer, scheduling the optimal schedule appointment during the first schedule gap of the first service provider.

2. The method of claim 1 further comprising determining a respective value for performing the service during a candidate service appointment in each of the set of schedule gaps and ranking the respective values.

3. The method of claim 2 further comprising determining the optimal service appointment based on the ranking of the candidate service appointments.

4. The method of claim 3 further comprising generating the offer to the customer based on the respective value of the optimal service appointment.

5. The method of claim 1 further comprising retrieving service provider qualification requirements and service provider efficiency from the service information system; wherein the set of service providers meet the service provider qualification requirements; and wherein the optimal determination includes service provider efficiency, the optimal determination including service timing, travel distance from the respective prior location and to the respective subsequent location, any inventory restocking costs, and a value of time not utilized in each schedule gap.

6. The method of claim 1 wherein inventory available to the service providers include inventory available on a set of vehicles, each vehicle associated with one of the service providers.

7. The method of claim 1 further comprising identifying an opening in the set of schedules for the first service provider, identifying locations of adjoining appointments for the first service provider, and identifying potential customers proximately close to the identified locations.

8. The method of claim 7 further comprising providing an offer to one of the potential customers; and responsive to receiving the confirmation from the customer, scheduling any inventory restocking for the first service provider.

9. The method of claim 7 further comprising determining a respective value for providing a potential service appointment for each potential customer and ranking the potential service appointments, wherein providing the offer to one of the potential customers includes providing the offer based on the ranking of the potential service appointments.

10. The method of claim 4 further comprising retrieving service provider qualification requirements and service provider efficiency from the service information system; identifying an opening in the set of schedules for a first service provider; identifying locations of adjoining appointments for the first service provider; and identifying potential customers proximately close to the identified locations; determining a respective value for providing a potential service appointment for each potential customer; ranking the potential service appointments; providing an offer to one of the potential customers based on the ranking of the potential service appointments; and responsive to receiving the confirmation from the customer, scheduling any inventory restocking for the first service provider; wherein supplies available to the service providers include supplies available on a set of vehicles, each vehicle associated with one of the service providers; wherein the set of service providers meet the service provider qualification requirements; and wherein the optimal determination includes service provider efficiency, the optimal determination including service timing, travel distance from the respective prior location and to the respective subsequent location, any inventory restocking costs, and a value of time not utilized in each schedule gap.

11. A computer program product for optimizing a service provider schedule and route, the computer program product comprising a non-transitory computer readable storage medium having program instructions embodied therewith, the program instructions executable by a processing circuit to cause the device to perform a method comprising:
receiving a service request from a customer, the service request including customer timing and location requirements;
retrieving, from a service information system, service timing and inventory for performing a service to fulfill the service request;
retrieving, from a scheduling system, a set of gaps in schedules that meet the customer timing and location requirements for a set of service providers which meet the service timing and inventory requirements, each schedule gap having a respective prior and subsequent location;
utilizing a processor to determine an optimal schedule appointment for a first one of the set of service providers to perform the service during a first one of the set of schedule gaps, the optimal determination including service timing;
transmitting an offer to the customer for the first service provider to perform the service to fulfill the service request during the optimal schedule appointment in the first schedule gap; and
responsive to receiving a confirmation from the customer, scheduling the optimal schedule appointment during the first schedule gap of the first service provider.

12. The computer program product of claim 11 further comprising determining a respective value for performing the service during a candidate service appointment in each of the set of schedule gaps and ranking the respective values.

13. The computer program product of claim 12 further comprising determining the optimal service appointment based on the ranking of the candidate service appointments; and generating the offer to the customer based on the respective value of the optimal service appointment.

14. The computer program product of claim 11 further comprising retrieving service provider qualification requirements and service provider efficiency from the service information system; wherein the set of service providers meet the service provider qualification requirements; and wherein the optimal determination includes service provider efficiency, the optimal determination including service timing, travel distance from the respective prior location and to the respective subsequent location, any inventory restocking costs, and a value of time not utilized in each schedule gap.

15. The computer program product of claim 11 wherein inventory available to the service providers include inventory available on a set of vehicles, each vehicle associated with one of the service providers.

16. A data processing system for optimizing a service provider schedule and route, the data processing system comprising:
a processor; and
a memory storing program instructions which when executed by the processor execute the steps of:
receiving a service request from a customer, the service request including customer timing and location requirements;
retrieving, from a service information system, service timing and inventory for performing a service to fulfill the service request;
retrieving, from a scheduling system, a set of gaps in schedules that meet the customer timing and location requirements for a set of service providers which meet the service timing and inventory requirements, each schedule gap having a respective prior and subsequent location;
utilizing a processor to determine an optimal schedule appointment for a first one of the set of service providers to perform the service during a first one of the set of schedule gaps, the optimal determination including service timing;
transmitting an offer to the customer for the first service provider to perform the service to fulfill the service request during the optimal schedule appointment in the first schedule gap; and
responsive to receiving a confirmation from the customer, scheduling the optimal schedule appointment during the first schedule gap of the first service provider.

17. The data processing system of claim 16 further comprising determining a respective value for performing the service during a candidate service appointment in each of the set of schedule gaps and ranking the respective values.

18. The data processing system of claim 17 further comprising determining the optimal service appointment based on the ranking of the candidate service appointments; and generating the offer to the customer based on the respective value of the optimal service appointment.

19. The data processing system of claim 16 further comprising retrieving service provider qualification requirements and service provider efficiency from the service information system; wherein the set of service providers meet the service provider qualification requirements; and wherein the optimal determination includes service provider efficiency, the optimal determination including service timing, travel distance from the respective prior location and to the respective subsequent location, any inventory restocking costs, and a value of time not utilized in each schedule gap.

20. The data processing system of claim 16 wherein inventory available to the service providers include inventory available on a set of vehicles, each vehicle associated with one of the service providers.
